(19) United States
(12) Patent Application Publication
(10) Pub. No.: US 2013/0000500 A1
(43) Pub. Date: Jan. 3, 2013

(54) PAD PRINTING MACHINE

(75) Inventor: Wilfried Philipp, Kornwestheim (DE)

(73) Assignee: Tampoprint AG, Korntal-Munchingen (DE)

(21) Appl. No.: 13/536,046

(22) Filed: Jun. 28, 2012

(30) Foreign Application Priority Data
Jul. 1, 2011 (DE) 10 2011 078 532.9

(51) Int. Cl. B41F 1/38

(52) U.S. Cl. 101/163

(57) ABSTRACT

A pad printing machine includes a printing plate holder, a printing plate attached on the printing plate holder, a device for inking the printing plate, and a pad configured to lift the ink off the printing plate and transferring the ink to an object to be printed. At least one of the printing plate holder, the device for inking the printing plate and the pad is moveably arranged, with the printing plate being supported for displacement and rotation.

### CROSS-REFERENCES TO RELATED APPLICATIONS

This application claims the priority of German Patent Application, Serial No. 10 2011 078 532.9, filed Jul. 1, 2011, pursuant to 35 U.S.C. 119(a)-(d), the content of which is incorporated herein by reference in its entirety as if fully set forth herein.

### BACKGROUND OF THE INVENTION

The present invention relates, in general, to a pad printing machine.

The following discussion of related art is provided to assist the reader in understanding the advantages of the invention, and is not to be construed as an admission that this related art is prior art to this invention.

In a pad printing machine, ink is lifted with a pad from a printing plate, which has previously been inked with a suitable device, and transferred to an object to be printed. A pad printing machine allows printing of even uneven objects, because the pad is typically made from silicone rubber and thus able to adapt to the shape of the object to be printed. Such a pad printing machine is typically integrated in a production facility for printing the objects being printed, so that the objects can be printed immediately after their production. In addition to the demand for a flawless printing of the objects, there is also a demand to be able to apply different prints, for example sequential serial numbers or lot numbers, to identical objects.

It would be desirable and advantageous to provide an improved pad printing machine which obviates prior art shortcomings and allows the application of identical or different prints to identical or different objects, without requiring a change of the printing plate while yet operating at a printing speed which at least equals a printing speed of conventional pad printing machines.

### SUMMARY OF THE INVENTION

According to one aspect of the present invention, a pad printing machine includes a printing plate holder, a printing plate attached on the printing plate holder, a device for inking the printing plate, and a pad configured to lift the ink off the printing plate and transferring the ink to an object to be printed. At least one of the printing plate holder, the device for inking the printing plate and the pad is moveably arranged, with the printing plate being supported for displacement and rotation.

In a pad printing machine according to the present invention, a plurality of different engravings can advantageously be applied to the printing plate and the printing plate can not only be shifted when moving from the inking or rest position into the ink removal position, but also rotated. The pad may hence be placed onto two different engravings, so that different prints, such as codes, markings, information, images, etc. can be applied to the object to be printed. Advantageously, the printing plate may be rotated about at least 360°. The angular divisions around the circumference can be uniform or different.

According to another advantageous feature of the present invention, the printing plate may be formed as a disk, wherein the disk may advantageously be circular. The printing plate may carry several engravings which may be arranged concentrically about the center of rotation. By selecting the rotational position, the particular engraving may be selected which, on one hand, is inked and onto which, on the other hand, the pad is pressed for lifting off the ink.

According to another advantageous feature of the present invention, the engravings may be arranged on several concentric circles about the center of rotation. In this way, the number of the engravings arranged on the printing plate can be readily increased.

To increase the service life of the printing plate and improve the quality of the prints, the printing plate may advantageously be made from steel or from a ceramic material. Such printing plates can be readily and quickly machined with a laser, whereby engravings of arbitrary shape can be produced.

According to another advantageous feature of the present invention, the printing plate may be a multi-color printing plate. A single engraving may be inked with several printing inks or an individual print on the object to be printed may be produced by several imprints, using different engravings which are inked differently.

According to another advantageous feature of the present invention, the printing plate may be driven by a pancake motor. Alternatively, the printing plate may have a gear rim which can then be driven by a sprocket. Such drives can attain a positioning accuracy of the printing plate of 1 μm or 3 arc minutes. The drive may be electrical, mechanical, pneumatic or electromechanical.

According to another advantageous feature of the present invention, to apply new engravings to the printing plate, the pad printing machine according to the invention may have a laser engraving the printing plate. This laser is capable of producing on the printing plate a new engraving in fractions of a second. This can be done, for example, in the rest position of the printing plate.

To remove ink residues from the pad and/or residues produced on the surface of the printing plate during laser engraving, the pad printing machine may advantageously include a residual ink removal device onto which the pad is pressed.

According to another advantageous feature of the present invention, the position of the printing plate, in particular its rotational position may be freely programmable. The printing plate may also assume its rest position at different positions, thereby reducing wear.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective view of a pad printing machine according to the present invention; and

FIG. 2 shows a detailed view illustrating a rotatable printing plate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. it should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

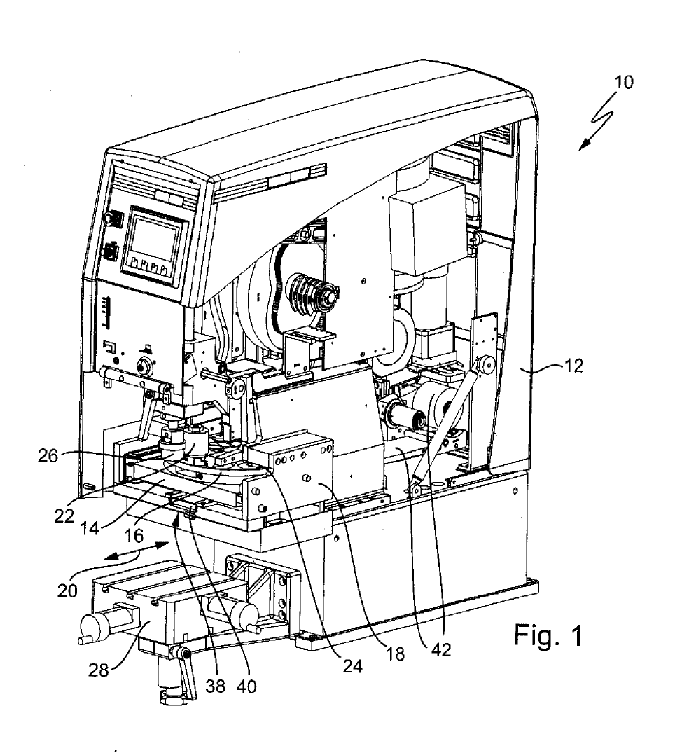

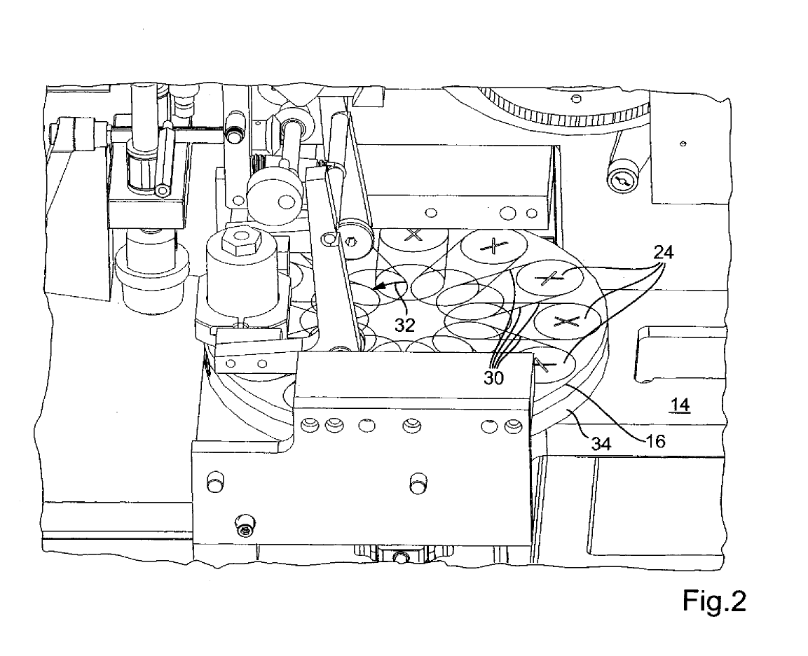

Turning now to the drawing, and in particular to FIG. 1, there is shown a pad printing machine according to the present invention, generally designated by reference numeral 10 and including a machine frame 12 on which a printing plate holder 14 is attached. A printing plate 16, which is provided with a number of engravings 24 disposed next to each other, is arranged on the printing plate holder 14, as can be clearly seen in FIG. 2. The printing plate holder 14 is disposed in a transport device 18 constructed to move the printing plate holder 14 back and forth in the direction of the double arrow 20. A squeegee container 22, with which the engravings 24 are inked, is disposed above the printing plate 16. This squeegee container 22 rests on the top side of the printing plate 16. The ink which is distributed into the respective engraving 24 with the squeegee container 22 resides inside the squeegee container 22. The squeegee process is carried out with the squeegee container 22, in particular with the rotating ring cutter, by way of which the squeegee container 22 rests on the printing plate 16. The printing plate 16 is moved with the transport device 18 underneath the squeegee container 22 in the direction of the double arrow 20. FIG. 1 shows the printing plate 16 in the inking position. The printing plate is moved from this position outwardly towards a pad 26, so that the inked engraving 24 is positioned underneath the pad. The pad 26 is pressed onto the engraving 24, thereby lifting the ink off the engraving 24. The pad 26 is then again raised and the printing plate retracts in the opposite direction. The pad 26 is then once more moved downward and pressed onto an object to be printed. The object itself is not illustrated, but only its holder 28.

FIG. 2 shows an enlarged view of the printing plate 16 with a plurality of engravings 24 arranged concentrically on the printing plate 16. The printing plate 16 which retracts after the ink has been removed by the pad 26 can return to the illustrated inking position, so that the same engraving 24 is again inked. The travel paths are indicated by the lines 30.

In the event a different engraving 24 is to be inked, the printing plate 16 is rotated by a certain angle, after the pad 26 has been lifted off the printing plate 16 in the ink removal position or during the return of the printing plate 16 into the inking position. Such lateral displacement is indicated by the arrow 32. In this way, the adjacent engraving 24 is inked. It will be understood that the rotation angle can also be greater than the illustrated angle. The printing plate 16 is rotated with a pancake motor 34 which is arranged on the printing plate holder 14 and which supports the printing plate 16 and rotates the same about a center of rotation.

A residual ink removal device 38 is disposed underneath the printing plate holder 14. The residual ink removal device 38 has a plate 40 which can be moved into the vertical transport path of the pad 26 in the direction of the arrow 20; a foil 42 on which the pad 26 is pressed for cleaning is tensioned with the plate 40. The plate 40 is extended in the direction of the arrow 20 only when needed and has a rest position which is illustrated in FIG. 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A pad printing machine, comprising:
a printing plate holder;
a printing plate attached on the printing plate holder and supported for displacement and rotation;
a device for inking the printing plate; and
a pad configured to lift ink off the printing plate and transferring the ink to an object to be printed,
wherein at least one of the printing plate holder, the device for inking the printing plate and the pad is moveably arranged.

2. The pad printing machine of claim 1, wherein the printing plate is constructed as a disk.

3. The pad printing machine of claim 2, wherein the disk is circular.

4. The pad printing machine of claim 1, wherein the printing plate carries a plurality of engravings.

5. The pad printing machine of claim 4, wherein the plurality of engravings are arranged concentrically about a center of rotation.

6. The pad printing machine of claim 4, wherein the plurality of engravings are arranged on several concentric circles around the center of rotation.

7. The pad printing machine of claim 1, wherein the printing plate is made from steel or from a ceramic material.

8. The pad printing machine of claim 1, wherein the printing plate is a multi-color printing plate.

9. The pad printing machine of claim 1, further comprising a pancake motor driving the printing plate.

10. The pad printing machine of claim 1, further comprising a laser configured to engrave the printing plate.

11. The pad printing machine of claim 1, further comprising a residual ink removal device.

12. The pad printing machine of claim 11, wherein the residual ink removal device is disposed underneath the printing plate or underneath the printing plate holder.

13. The pad printing machine of claim 11, wherein the residual ink removal device is configured to be moved into a vertical transport path of the pad.

14. The pad printing machine of claim 11, wherein the residual ink removal device has a rest position disposed underneath the printing plate or underneath the printing plate holder.

15. The pad printing machine of claim 1, wherein a position of the printing plate is freely programmable.

16. The pad printing machine of claim 1, wherein a rotational position of the printing plate is freely programmable.
